(19) United States
(12) Patent Application Publication
(10) Pub. No.: US 2015/0204265 A1
(43) Pub. Date: Jul. 23, 2015

(54) METHOD FOR OPERATING AN INTERNAL COMBUSTION ENGINE HAVING INTAKE MANIFOLD

(71) Applicant: Robert Bosch GmbH, Stuttgart (DE)

(72) Inventors: Marko Lorenz, Grossbottwar (DE); Andreas Posselt, Muehlacker (DE); Andreas Gutscher, Markgroeningen (DE); Michael Fischer, Niefern-Oeschelbronn (DE)

(73) Assignee: Robert Bosch GmbH, Stuttgart (DE)

(21) Appl. No.: 14/415,116

(22) PCT Filed: Jun. 21, 2013
(86) PCT No.: PCT/EP2013/063012

§ 371 Date: Jan. 15, 2015

(30) Foreign Application Priority Data
Jul. 17, 2012 (DE) 102012212464.0

(51) Int. Cl. F02D 41/30; F02M 61/14; F02D 41/34

(52) U.S. Cl. CPC F02D 41/3094; F02D 41/345; F02M 61/145

(57) ABSTRACT

In an internal combustion engine having manifold injection, each cylinder is assigned at least one first injection device and one second injection device. The first injection device is at least intermittently actuated at a different crank angle than the second injection device.

### FIELD OF THE INVENTION

The present invention relates to a method for operating an internal combustion engine having intake manifold injection.

### BACKGROUND INFORMATION

Already believed to be understood are four-stroke internal combustion engines, in which the fuel is injected into an intake manifold upstream from an intake valve of the internal combustion engine. Since most modern internal combustion engines are believed to have two intake valves per cylinder, it is also believed to be understood to provide two injection devices per cylinder. A separate injection device can be assigned to each intake valve. The injection devices are actuable at a crank angle that lies relatively far in advance of the particular crank angle at which the intake valves open. The actuation of the injection devices can take place simultaneously for each cylinder.

### SUMMARY OF THE INVENTION

The present invention has the objective of reducing an operating noise of the internal combustion engine.

This objective may be achieved by a method having the features described herein. Further refinements of the present invention are indicated in the further descriptions herein. Features that are important for the present invention are furthermore to be found in the following description and the drawings.

The present invention is based on the understanding that noise pulses that are spaced apart by less than approximately ten milliseconds are conceived as a single event by the human ear.

Moreover, individually occurring noises pulses, i.e., such that occur at only a low pulse rate, are perceived as more annoying than more frequently occurring noise pulses. The subjective acoustic irritation potential thus drops with an increasing pulse rate and only a certain acoustic roughness still results.

In the present invention, the injection devices of a cylinder are no longer actuated simultaneously but one after the other, i.e., at different crank angles. For one, this reduces the intensity of the sound pulse generated by the actuation of the injection devices, since the actuation of the injection devices per cylinder is resolved into two less intense and individually perceivable sound events. Furthermore, the acoustic frequency, i.e., the pulse rate, is increased, which reduces annoying noise subjectively perceived by the user.

Because of the offset actuation of the injection devices, a noise is therefore generated that the user or listener perceives more as a pleasant “roughness” than the noise generated in the simultaneous actuation that was the rule until now.

In a first further development of the method of the present invention, it is proposed that the injection devices of all cylinders are operated across two full crankshaft revolutions in an evenly distributed pattern. This leads to a uniform noise having twice the frequency and half the individual pulse intensity, which causes an especially marked reduction in the operating noise. Given two injection devices per cylinder, the crank angle at which the two injection devices must be operated at an offset per cylinder is able to be calculated by dividing the number 360 by the number of cylinders. In a four cylinder internal combustion engine, this crank angle thus amounts to 90 degrees, and in a six cylinder internal combustion engine it amounts to 60 degrees.

It is furthermore proposed that the first injection device is actuated at a different crank angle than the second injection device only when the internal combustion engine is in a certain operating range, especially when a rotational speed of a crankshaft and/or a torque lie(s) below a limit value. This takes the fact into account that the method of the present invention is especially advantageous in an idling operation of the internal combustion engine, for instance, or at a low load. The other noises of the internal combustion engine are comparatively low in these operating ranges, so that the noise generated by the injection devices is then perceived as especially annoying. Furthermore, there are operating ranges of an internal combustion engine that lend themselves more readily than others to a division of the injections to different instants.

It is also possible that the difference in the crank angles at which the two injection devices of a cylinder are actuated is a function of an actual operating parameter and/or an actual operating range of the internal combustion engine. When ascertaining the difference in the crank angles, for example, it is conceivable to also consider the influence of the temporally offset actuation on the exhaust gas values and the consumption values of the internal combustion engine as well as on a current operating temperature, an operating state of an auxiliary component, etc. It is also conceivable and especially advantageous if the difference is made dependent upon at least one current acoustic quantity. This quantity, for instance, could be a volume but also a frequency. If appropriate, even a type of regulation is conceivable in which the acoustic quantity is adjusted to a target value (frequency) or a minimum value (volume) by varying the difference of the crank angles. The acoustic quantity is able to be recorded by a structure-borne noise sensor disposed on the internal combustion engine, for instance, or by a microphone situated in the passenger compartment of the motor vehicle, for example.

In the following text the present invention will be elucidated with reference to the appended drawings.

### BRIEF DESCRIPTION OF THE DRAWINGS

FIG. 1 shows a schematic plan view of an internal combustion engine.

FIG. 2 shows four diagrams, in which a piston travel, an intake valve opening period and actuation periods of injection devices have been plotted over the individual crank angles for each cylinder of the internal combustion engine from FIG. 1.

FIG. 3 shows a flow chart of a method for operating the internal combustion engine from FIG. 1.

### DETAILED DESCRIPTION

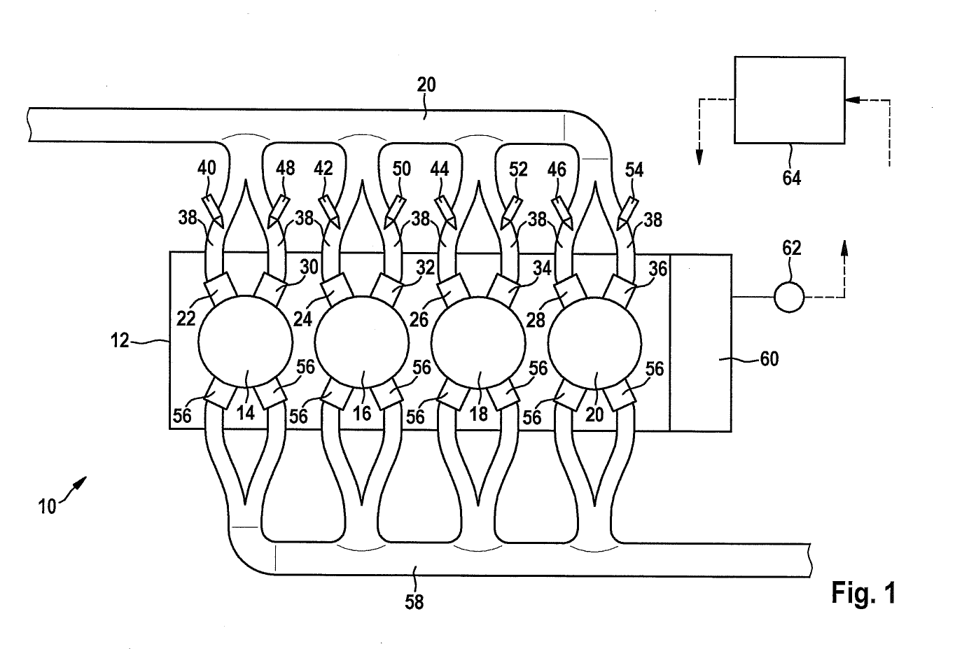

In FIG. 1 an internal combustion engine is denoted by reference numeral 10 overall. It is a four cylinder, four stroke internal combustion engine.

It includes an engine block 12 in which four cylinders 14, 16, 18 and 20 are provided. A respective first intake valve 22, 24, 26 or 28 and a second intake valve 30, 32, 34 or 36 is associated with each cylinder 14 through 20. A separate intake duct 38 leads to each intake valve 22 through 36, and a first injection device 40 through 46 and a second injection device 48 through 54 are assigned to each injection valve 22 through 36 in respective intake duct 38. In addition, two outlet valves 56, which lead to an exhaust gas pipe 58, are part of each cylinder 14 through 20.

Internal combustion engine 10 also includes a crankshaft 60 (only indicated symbolically), whose rotational speed and position are detected by a crankshaft sensor 62. In addition, a control and regulation device 64, which controls and regulates the operation of internal combustion engine 10, is part of internal combustion engine 10. For this purpose, control and regulation device 64 receives the signals from various sensors that record current operating quantities of internal combustion engine 10 such as the signal from crankshaft sensor 62, for example. Control and regulation device 64 controls various actuating devices of internal combustion engine 10, such as injection devices 40 through 54.

Additional components of internal combustion engine 10, e.g., spark plugs, throttle valves, exhaust-gas purification devices, the fuel system including fuel pump, etc., are not shown in FIG. 1 for reasons of clarity.

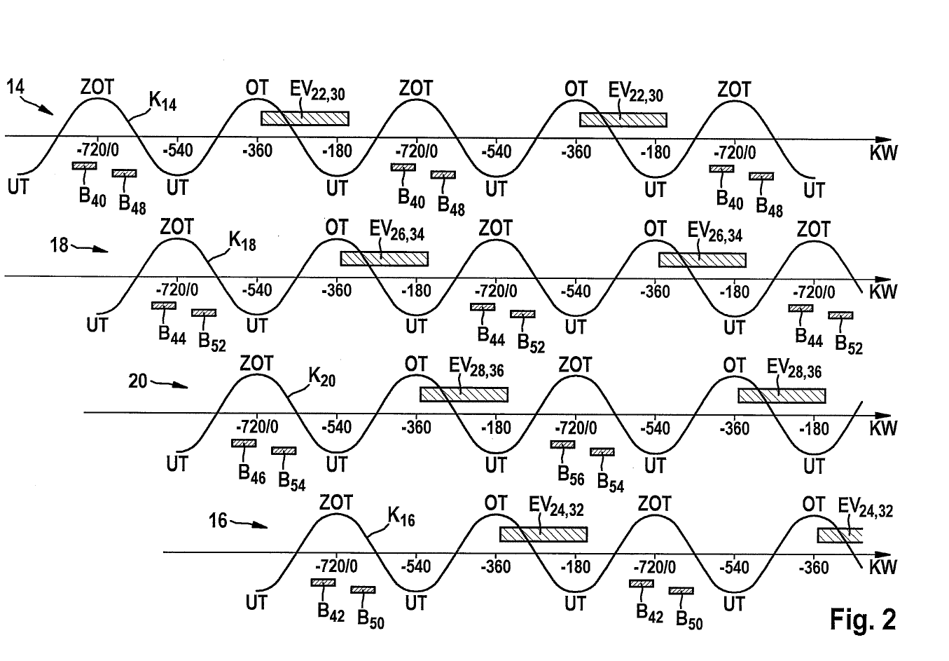

As mentioned previously, internal combustion engine 10 has a first intake valve 22 through 28 and a first injection device 40 through 46 as well as a second intake valve 30 through 36 and a second injection device 48 through 54 per cylinder 14 through 20. The control or actuation of injection devices 40 through 54 will now be explained with reference to FIG. 2.

In FIG. 2, four diagrams have been plotted, whose abscissa corresponds to a crank angle KW in each case. The top upper diagram in FIG. 1 applies to first cylinder 14, the second diagram from the top to third cylinder 18, the third diagram from the top to fourth cylinder 20, and the diagram all the way at the bottom, to second cylinder 16. A sinusoidal curve denoted by Kᵢ (i-14 through 20) in each diagram supplies information about the position of the particular piston of cylinder 14 through 20. At 0° or minus 720° ZW, the piston is at top dead center ignition (ZOT), at a crank angle KW of −180°, the piston is at a lower dead center UT between intake and compression stroke. At a crank angle KW of −360°, the piston is at a top dead center OT between exhaust stroke and intake stroke. At a crank angle KW of −540°, the piston is at a lower dead center UT between working stroke and exhaust stroke.

Also plotted in FIG. 1 are the opening periods of intake valves 22 through 36 of each cylinder 14 through 20. They are denoted by EVᵢ there, i=22 through 36 for intake valves 22 through 36. It is clear that intake valves 22 through 36 open for each cylinder 14 through 20 shortly after the start of the aspiration phase and that they close shortly after the start of the compression phase.

Finally, the actuating periods of injection devices 40 through 54 for each cylinder 14 through 20 have been plotted in FIG. 2. The actuating periods have been designated by the letter B, which is indexed by the reference numeral of the particular injection device 40 through 54. It is obvious that first injection devices 40, 42, 44 and 46 are actuated during actuating periods B₄₀, B₄₂, ₄₂ B₄₄, and B₄₆, which begin at a crank angle KW of −770° in this example and end at a crank angle KW of −720°.

Second injection devices 48 through 54 are actuated during actuating periods B₄₈, B₅₀, B₅₂, and B₅₄, respectively, which begin at a crank angle KW of −680° (for example) and end at a crank angle KW of −630°. That is to say, first injection devices 40 through 46 are actuated at a different crank angle (in this instance, −770° to −720° KW by way of example) than second injection devices 48 through 54 (in this instance, at −680° to −630° KW by way of example). It can also be seen that a crank angle difference of 90° lies between the start of actuating period B₄₀ and the start of actuating period B₄₈, and another crank angle difference of 90° lies between the start of actuating period B₄₈ and the start of actuating period B₄₄, etc. In other words, actuating periods Bᵢ of injection devices i (i=40 through 54) are completely evenly distributed across two full crankshaft revolutions, which corresponds to a crank angle of 720° KW. The difference between crank angle KW at which first injection device 40 through 46 is actuated, and the crank angle at which second injection device 48 through 54 is actuated, therefore corresponds, as already mentioned, to a crank angle of 90° KW, which is calculated by dividing the number 360 by the number (in this instance 4) of cylinders 14 through 20 of internal combustion engine 10.

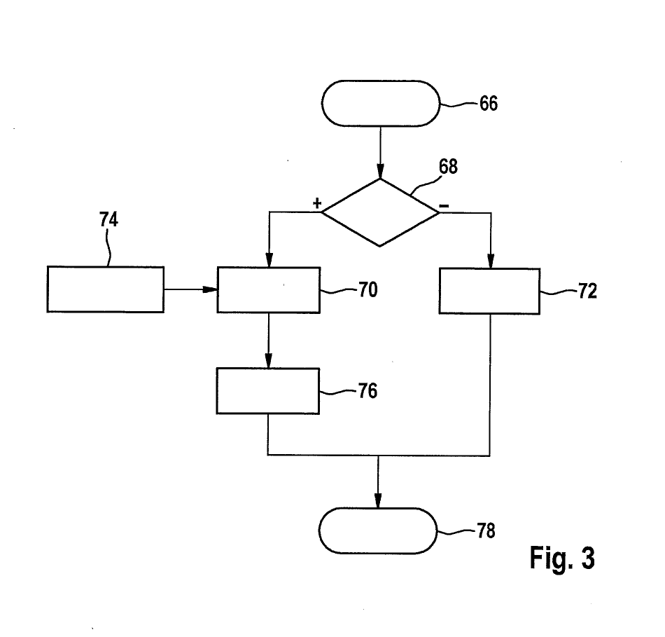

In an actuation of injection devices 40 through 44, a method elucidated in the following text with reference to FIG. 3 will be used. Following a start block 66, in block 68 it is checked in which operating state internal combustion engine 10 happens to be just then. To do so, for example, the signal from crankshaft sensor 62 is compared to a limit value. If the rotational speed of crankshaft 60 is below a predefined limit value, branching to a block 70 takes place, whereas a switch to block 72 takes place in the other case. According to block 72, first injection devices 40 through 46 and second injection devices 48 through 54 are operated simultaneously; in other words, it is precisely not the case that the actuation discussed in FIG. 2, which is offset at 90° there, takes place.

In block 70, the differential crank angle between the respective first actuations B₄₀ through B₄₆ and the respective second actuations B₄₈ through B₅₄ is ascertained, i.e., as a function of the actual operating variables of the internal combustion engine such as an actual operating temperature, an actual torque requested by the user of internal combustion engine 10, an operating state of an exhaust purification system, etc. These operating variables are sketched by block 74. In a block 76, second injection devices 48 through 54 are then actuated at an offset in relation to first injection devices 40 through 46, i.e., using the differential crank angle ascertained in block 70 (in the example of FIG. 2, it is 90°). The method ends in a block 78.

The method shown in FIG. 3 is stored as a computer program in a memory of control and regulation device 64.

1-7. (canceled)

8. A method for operating an internal combustion engine having manifold injection, the method comprising:
assigning each cylinder at least one first injection device and one second injection device; and
intermittently operating the first injection device at a different crank angle than the second injection device.

9. The method of claim 8, wherein the injection devices of all cylinders are actuated in an evenly distributed manner across two full crankshaft revolutions.

10. The method of claim 9, wherein, for two injection devices per cylinder, the injection devices per cylinder are actuated in a manner that is offset by a crank angle that corresponds to a value of 360 divided by the number of cylinders.

11. The method of claim 8, wherein the first injection device is actuated at a different crank angle than the second injection device only when the internal combustion engine is in a certain operating range, especially when a rotational speed of a crankshaft and/or a torque lie(s) below a limit value.

12. The method of claim 8, wherein the difference of the crank angles at which the injection devices of a cylinder are actuated is a function of an actual operating parameter, including at least one of an acoustic quantity and an actual operating range of the internal combustion engine.

13. A computer readable medium having a computer program, which is executable by a processor, comprising:
a program code arrangement having program code for operating an internal combustion engine having manifold injection, by performing the following:
assigning each cylinder at least one first injection device and one second injection device; and
intermittently operating the first injection device at a different crank angle than the second injection device.

14. A control/regulation device for an internal combustion engine, comprising:
a computer readable medium having a computer program, which is executable by a processor, including a program code arrangement having program code for operating an internal combustion engine having manifold injection, by performing the following:
assigning each cylinder at least one first injection device and one second injection device; and
intermittently operating the first injection device at a different crank angle than the second injection device.
